(19) United States
(12) Patent Application Publication
(10) Pub. No.: US 2009/0093236 A1
(43) Pub. Date: Apr. 9, 2009

(54) DELIVERY OF A SERVICE

(76) Inventors: Vijay Balan, Lisle, IL (US); Stephen Ulanoski, Chanhassen, MN (US); Murali Krishna Balakumar, Naperville, IL (US)

Correspondence Address: BUCKLEY, MASCHOFF & TALWALKAR, LLC;GENERAL ELECTRIC COMPANY, 50 LOCUST AVENUE, NEW CANAAN, CT, 06840, US

(21) Appl. No.: 12/193,394

(22) Filed: Aug. 18, 2008

Related U.S. Application Data
(60) Provisional application No. 60/956,465, filed on Aug. 17, 2007.

(51) Int. Cl. H04W 12/06; H04W 4/02

(52) U.S. Cl. 455/411; 455/456.1

(57) ABSTRACT

A method and system for enrollment and delivery of a service, the method for enrolling including receiving a request for enrollment with a service from a user, the request for service being initiated by the user; authenticating the user associated with the mobile phone by verifying a mobile identification number (MIN) associated with the mobile phone device; determining a global positioning system (GPS) functionality of the mobile phone device; enrolling the user with the service based on the authenticating and the determined GPS functionality of the mobile phone device; and delivering an application associated with the service to the mobile phone device of the enrolled user, the delivered application including functionality based on the determined GPS functionality of the mobile phone device.

### RELATED APPLICATIONS

This application is based on, and claims priority to and benefit of provisional U.S. Application Ser. No. 60/956,645, filed on Aug. 17, 2007, the contents of which are hereby incorporated by reference in their entirety for all purposes.

### FIELD OF THE INVENTION

The present disclosure generally relates to a system and method for enrolling and delivering a service, and more particularly to a method and system of enrolling and delivering a service associated with a service delivered to a mobile phone device.

### BACKGROUND

The market penetration of mobile communications devices, such as mobile phones, and the availability of associated communication networks permit the users of such devices to communicate with others from many different, if not most, locations. One of the reasons users routinely keep a mobile phone device in their immediate possession is that having their mobile phone device provides them with a sense of security knowing that they will be able to contact others and/or be contacted in the event of an emergency. However, in a number of emergency and other situations a mobile phone device user may not be able to sufficiently relate an accurate position of their location to an emergency responder or other person or device.

Global positioning system (GPS) devices and devices incorporating GPS functionality are becoming more readily available and accurate. For instance, a number of mobile phones and other mobile devices including communication functionalities include GPS capabilities. However, there exists a need to provide a system and method of efficiently enrolling and delivering a service to a mobile phone device.

### BRIEF SUMMARY

In some embodiments, a system and method for enrolling an entity (e.g., a user) with a service is provided. The system may provide an environment for implementing a method that may include selecting a service (e.g., a roadside assistance service) using a mobile phone device as an interface to the service, authenticating the user with a carrier associated with the mobile phone device, determining a GPS (global positioning system) functionality of the mobile phone device, and enrolling the user with the service based on the authentication and the determined GPS functionality of the mobile phone device. The system and method may further facilitate downloading an application associated with the service to the mobile phone device of the enrolled customer based on the GPS functionality of the phone device, maintaining a record of the enrolled user with the record including an indication of the GPS functionality of the phone device, and outputting, by the carrier, the record of the enrolled user.

As used herein, the term “mobile phone device” is used to refer to a mobile or handheld telephone device, such as a cellular telephone, a pager or a personal digital assistant. Further, as used herein, the term “user” may refer to a user of the systems or elements of the present invention as well as a “customer” of services provided pursuant to embodiments of the present invention.

In some embodiments, the enrollment method and system may include selecting a type of enrollment via the mobile phone device from a plurality of different enrollment types.

In some embodiments, a method to deliver a service includes (e.g., a roadside assistance service) initiating a request for the service for a user via a mobile phone device, gathering GPS data collected by the mobile phone device, sending the GPS data to a service provider, and placing a voice call to the service provider. The method may further include associating the sent GPS data with the placed voice call, determining a level of service to provide to the user, and dispatching a responder to a location associated with the GPS data and the determined level of service.

In some embodiments, the method may also include determining a location of the mobile phone device based on the GPS data and obtaining updated GPS data associated with the mobile phone device in response to the request for service from the user. The method may, in some embodiments, include maintaining a record of the user and authenticating the user in response to the request for service from the user.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is an illustrative diagram of a system and some associated data flows, according to some embodiments herein;

FIG. 2 provides an overview of an enrollment process and system, in accordance with some embodiments herein;

FIG. 3 is an illustrative depiction of an enrollment process and system, in accordance with some embodiments herein;

FIG. 4 is an exemplary illustration of a service delivery process and system, in accordance with aspects herein;

FIG. 5 is an exemplary illustration of a service delivery process and system from a user perspective, in accordance herewith; and

FIGS. 6-8 provide an overview of a service delivery process and system, in accordance herewith.

### DETAILED DESCRIPTION

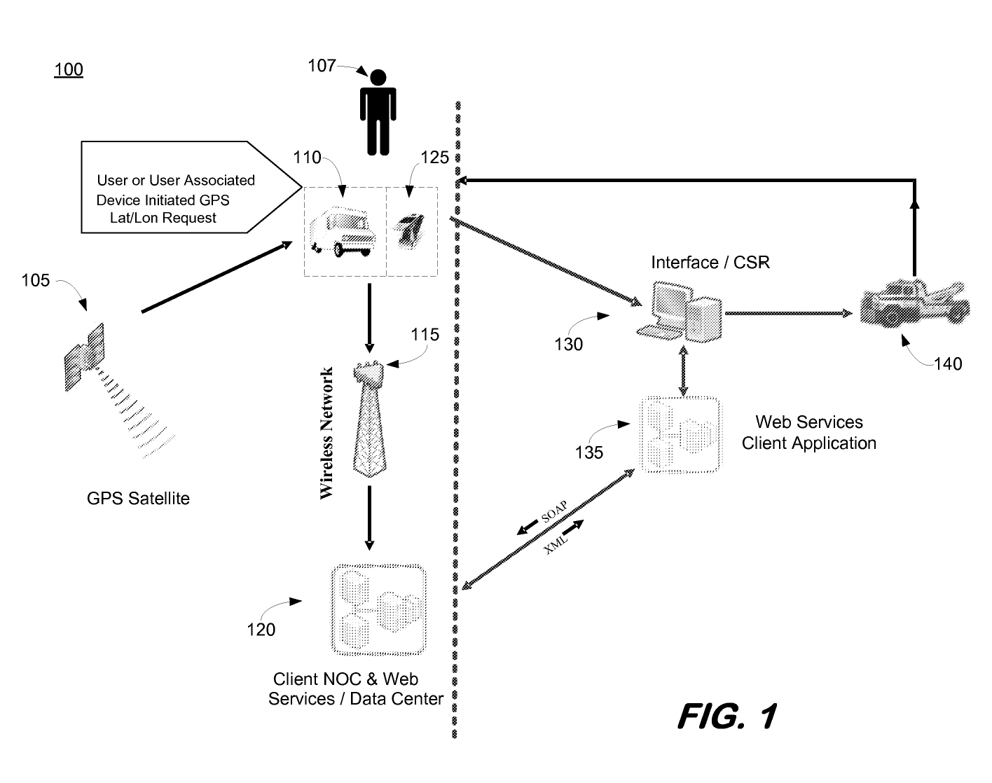

FIG. 1 shows an illustrative system 100 and exemplary data flows that may accompany system 100. In some embodiments, system 100 may facilitate enrollment in a service, a request for the service by an entity enrolled in the service, and a delivery of the service in response to the request for the service.

It should be appreciated that system 100 is an example of a system, including subsystems and devices, that may be suitable for the implementation or supporting various aspects of the present disclosure. As such, system 100 may include more, fewer, and alternative components, devices, and systems than those specifically depicted in FIG. 1. Furthermore, the process flows shown associated with system 100 are presented to provide an illustrative example, rather than an exhaustive or limiting fixed rendering of some of the functionality and capabilities of system 100. The process flows may be varied from those expressly depicted in FIG. 1, in some instances depending on the configuration of software and hardware components of system 100.

In some embodiments, a GPS satellite 105, either alone or in cooperation with other devices and systems, may produce, generate, or otherwise provide GPS data regarding a user 107 associated with a car and/or a fleet vehicle 110. In an embodiment, user 107 may also be a customer. In some additional embodiments herein, the GPS data may be provided from or with the assistance of GPS satellite 105 to user car or fleet vehicle 110. User car or fleet vehicle 110 may have a device (e.g. a Telematics Control Unit, either OEM or aftermarket) operable to receive the GPS data. In some other embodiments herein, the GPS data may be provided from or with the assistance of GPS satellite 105 to a mobile phone device 125 such as a mobile telephone that is operable to, at least, receive the GPS data. In instances where the mobile phone device includes GPS functionality or capabilities, mobile phone device 125 is referred to herein as being GPS enabled or as having a GPS functionality or capability.

As used herein, a GPS functionality or capability may include any location and navigational system, whether based on satellite, cellular, or radio signals alone or in combination. As such, a GPS functionality may include GPS, assisted GPS (AGPS), and location determinations based on an entity's position in a mobile phone network service area.

The GPS data may be forwarded from vehicle 110 and/or communication device 125 to a client NOC (network operations center) and web services/data center 120 via, for example, a wireless communications network 115 and/or a broadcasting network. In some embodiments, network 115 may include a mobile phone network. NOC 120 may be tasked with monitoring and maintaining records of the GPS data associated with user 107. The record of the GPS data may be updated at least periodically and include, for example, a latitude and longitude position of user 107, as obtained by customer car or fleet vehicle 110 and/or mobile phone device 125 associated with user 107.

System 100 may further facilitate a request for a service that uses GPS data maintained at NOC 120. The request for the service may be initiated by user 107 using a mobile phone device 125 having telephony functionality. In some instances, mobile phone device 125 may include a mobile telephone or a device that includes at least mobile telephone functionality.

User 107 may initiate the request for service by placing a voice call to a service provider 130. In the instance a GPS enabled mobile phone device 125 obtains or receives the GPS data, the GPS enabled mobile phone device 125 may be used by user 107 to initiate and place the voice call to service provider 130. In an embodiment, a user car or fleet vehicle 110 obtains or receives the GPS data. A wireless, landline, VOIP (voice over IP), walkie-talkie, PTT, Push To Talk device (e.g., push to talk over cellular), or any other voice communication device (not shown) may be used to initiate and place the voice call from user 107 to service provider 130.

Service provider 130 may have, for example, a customer service representative that receives the call from user 107. Service provider 130 may retrieve the GPS data from client NOC 120 using, for example, a request from a web services server 135. Service provider 130 may authenticate or otherwise verify user 107 is entitled to receive the requested service before, during, or after requesting the GPS data from client NOC 120.

As illustrated, the request for service received by client NOC 120 may be implemented using a SOAP (Simple Object Access Protocol) protocol and the response from client NOC 120 may be provided as an XML data exchange. It is noted that these, other, additional, fewer, or alternative communication protocols and data exchange formats may be used in one or more of the embodiments disclosed herein.

Upon receipt of the requested GPS data associated with the request for service, service provider 130 may generate a report based on the GPS data. The report may be provided to a responder 140. Responder 140 may be dispatched by service provider 130 to provide the requested level of service to user 107.

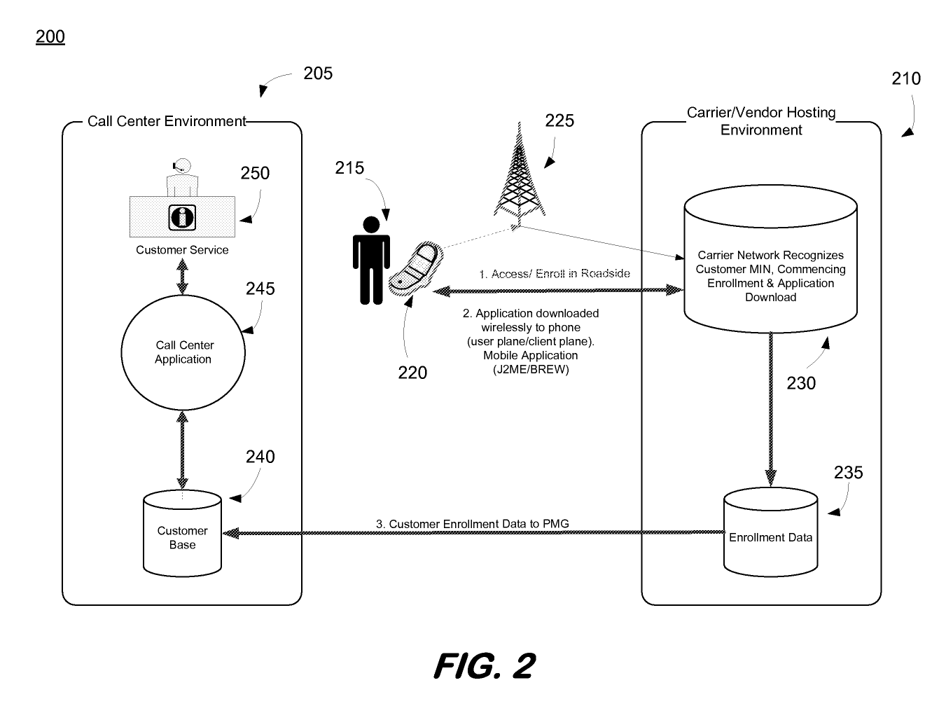

FIG. 2 provides an illustrative overview of an enrollment process and system 200, in accordance with some embodiments herein. As shown, a call center environment 205 and a carrier/vendor hosting environment 210 are provided to facilitate enrollment of a customer 215 with a service. Customer 215 may use mobile phone device 220 to access and enroll with the requested service over a communications network 225 associated with a mobile phones carrier or vendor. In the instance of a carrier, the carrier is associated with mobile phone device 220. In some embodiments, the carrier that provides phone services for the mobile phone device 220 subscribed to carrier network 225 also performs at least some of the functions associated with carrier/vendor hosting environment 210. In some embodiments, a vendor may perform at least some of the functions associated with carrier/vendor hosting environment 210.

Upon contacting carrier/vendor hosting environment 210 to enroll with the desired service and after the request for service is received by the carrier/vendor hosting environment 210 entity, customer 215 may be authenticated to verify the identity of the customer at 230. Authentication process 230 may include recognizing the customer (e.g., based on mobile identification number, MIN), commencing an enrollment process based on the request for service from customer 215, and determining a GPS functionality of mobile phone device 220. Enrollment data related to customer 215 may be stored with a database system 235.

Enrollment data may be transferred, copied, forwarded, or otherwise provided to call center environment 205 and stored and maintained in a customer database 240. A call center application 245 may be invoked to permit a customer service representative 250 to continue the enrollment process for the desired service initiated by customer 215.

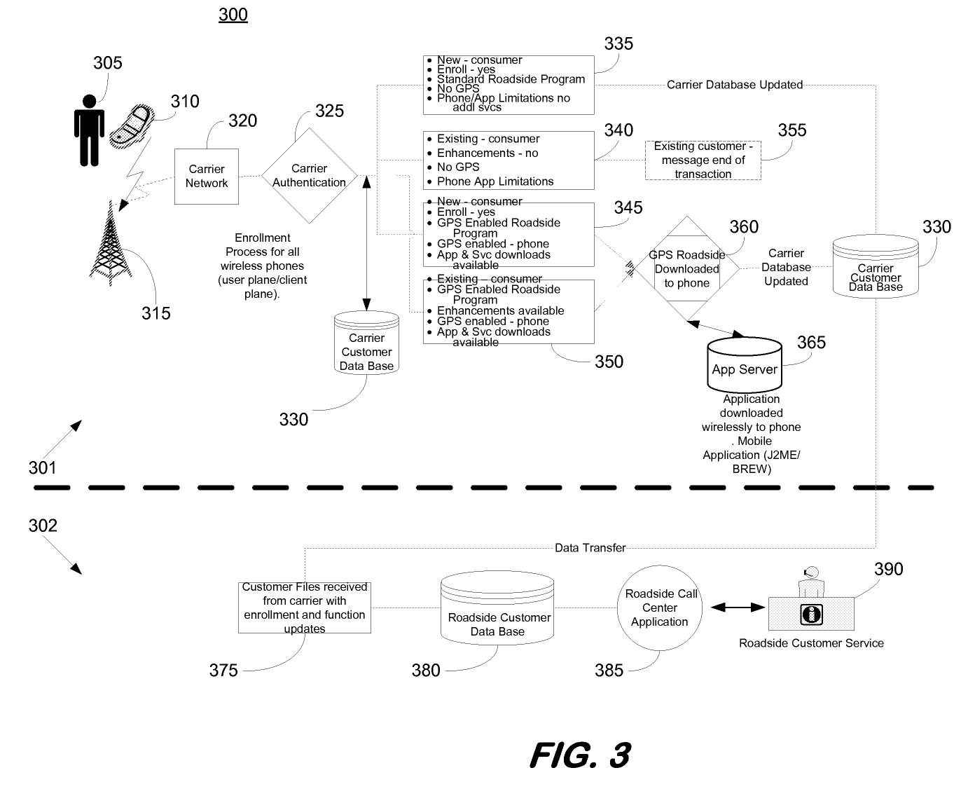

FIG. 3 is an illustrative depiction of an enrollment process and system, in accordance with some embodiments herein. In some embodiments, FIG. 3 illustrates a detailed view of some aspects of an enrollment process and system 300. The detailed view shown in FIG. 3 may, though not necessarily, include some or all of the aspects of the enrollment process and system depicted in FIG. 2. FIG. 3 illustrates, generally, an enrollment request and approval process 301 and a customer server and service request database 302 that cooperates with enrollment request and approval process 301 to enroll a customer 305 with a requested service. Referring back to FIG. 2, enrollment request and approval process 301 may be encompassed by carrier/vendor hosting environment 210 while customer server and service request database 302 may be captured by call center environment 205.

Customer 305 may initiate a request for service via mobile phone device 310 using an interface presented on mobile phone device 310. Mobile phone device 310 may include a number of buttons, keys, soft keys, icons, speakers, microphones, and other user interface input options to permit customer 305 to select and initiate the service enrollment request. Customer 305 may be presented with an enrollment greeting that includes, for example, terms and conditions for enrolling in the requested service. Upon acceptance of the terms and conditions of the enrollment process, customer identifying information may be authenticated at 325.

Customer 305 may be attempting to enroll for a first time. In such a case, the customer 305 may be authenticated as being a customer of carrier network 320. In some instances, the user may have previously enrolled with the service. Enrollment status of the user may be determined by referencing carrier customer database 330 to determine or assist in determining whether the user is a new or existing user of the requested service.

A GPS functionality of mobile phone device 310 may be determined by referencing carrier customer database 330 that contains a profile or listing of the GPS functionality of mobile phone device 310. In some instances, the GPS functionality of phone device 310 may be determined by, for example, polling phone device 310.

Next, the enrollment process of customer 305 may determine whether to download a service application to mobile phone device 310. Enrollment process 300 continues to operation 335 if it is determined that customer 305 is newly enrolled and the associated mobile phone device 310 lacks GPS functionality. From operation 335, carrier customer database 330, may be updated to include a record of the newly enrolled customer 305.

Enrollment process 300 continues to operation 340 if it is determined that customer 305 was previously enrolled (i.e., an existing user of one or more services) and the associated mobile phone device 310 lacks GPS functionality. Because this customer was already enrolled, carrier customer database 330 need not be updated and the enrollment processing terminates at operation 355.

Enrollment process continues at operation 345 in the instance it is determined that customer 305 is newly enrolled and the associated mobile phone device 310 includes GPS functionality. Enrollment process 300 continues to operation 350 if it is determined that customer 305 was previously enrolled and the associated mobile phone device 310 also includes GPS functionality. From operations 345 and 350, a GPS based service application is downloaded to the mobile phone device 310 via carrier network 320. The GPS based application may be obtained from application server 365.

It is noted that the GPS based service application downloaded to mobile phone device 310 may be based on Java™ (e.g., J2ME), BREW (Binary Runtime Environment for Wireless), and other technology platforms.

From operations 345 and 350, carrier customer database 330 may be updated to include a record of the enrolled and GPS functionality capable customer. The record(s) may include an indication of the version of the GPS based application downloaded by mobile phone device 310.

From carrier customer database 330, enrollment process 300 proceeds to transfer data including an indication of the enrollment status of customer 305 and the GPS functionality of mobile phone device 310 to customer server and service request database 302 where customer files, including updates, may be received from the carrier at operation 375. Records received from carrier customer database 330 may be stored at a service (e.g., a roadside assistance service) customer database and may be accessed by a customer service representative 390 using, for example, a call center application 385.

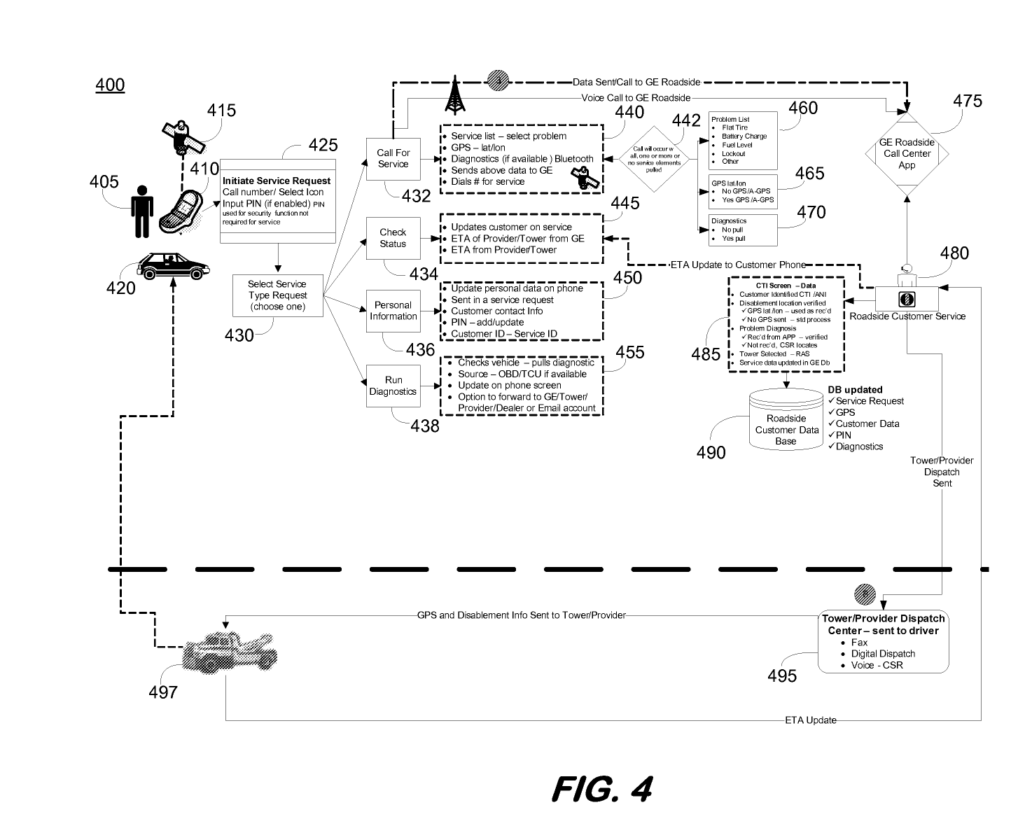

FIG. 4 is an exemplary illustration of a service delivery process and system illustrating a process 400 for a request for service and delivery of the requested service, in accordance herewith. Customer 405, enrolled or otherwise affiliated with a service, initiates a service request at operation 425 using mobile phone device 410. Mobile phone device 410 may communicate with satellite 415 and other systems and devices (not shown) to obtain GPS data indicative of the location of customer 405 and/or vehicle 420. Customer 405 may select an icon presented on a display of mobile phone device 410, select a desired level of service at 430, and, if requested or required, provide a security code or activate a security mechanism to continue with the service request.

The call for service may be automated to commence upon selection of an icon, key, soft key, or other user input mechanism at mobile phone device 410, including a particular sequence of icon, key, soft key, or other user inputs. The automated process may include dialing service provider 480 and sending the associated data without further input from customer 405.

Process 400 continues with at least one of operations 432-438. At operation 432, a call for service may be invoked using a call center application 475. The call for service may include placing a voice call to a service provider 480 (e.g., call center customer service representative) and providing GPS data and customer information to the service provider 480 via a data transmission. At operation 440, a particular problem(s) is indicated by customer 405, GPS data associated with the customer/mobile phone device/vehicle is gathered, and diagnostics of vehicle 420 are run and reported (if available). The GPS data, level of service requested, and diagnostics may be transmitted via a data transmission to service provider 480.

As indicated at 442, the call to service provider 480 may occur with all, one or more, or no service elements being pulled. The service elements relate to, for example, the problem prompting the service request 460, GPS data 465, and diagnostics 470.

The request for service may include a status check operation 434. The status check operation may include, for example, providing customer 405 with an updated status regarding the status of a service request and an estimated time delivery for the requested service. The estimates for time of delivery for the requested service may be obtained from service provider 480 and delivered in a voice call and/or other electronic communication format (e.g., text message, email, etc.) in real-time or near real-time.

The request for service may include providing personal information at operation 436. Personal information operation 436 may include, for example, updating personal information on mobile phone device 410 so that a service request provides accurate information with regard to a service request, updating customer contact information, updating a security mechanism, and updating a customer and or system identification mechanism. The updated personal information may be sent in an initial the service request call or a subsequent call.

The request for service may also include a diagnostics operation 455. The diagnostics herein may include, for example, running a diagnostics application to gather information about vehicle 420 using a device or system interface therewith. Data gathered as a result of diagnostics operation 438 may be presented on a display screen of phone device 410 and conveyed to customer 405, forwarded to service provider 480 (or others) via a wireless data transmission, messaging protocol, facsimile, email, and other modes of delivery.

Service provider 480 may be presented with a variety of data as indicated at 485. The data may be assembled based on both the data call and the voice call received as part of the service request initiated by customer 405. The data may be further stored in a record(s) in database system 490. Database system 490 may update records stored thereon based, for example, on information received as part of the request for service.

The request for service process 400 continues with service provider 480 dispatching service provider personnel such as a responder 497 to customer 405 based on, for example, the level of service requested, the level of service required as determined by service provider 480, an approved or authorized level of service, and available responders. The responder may be informed of the location and level of service requested via facsimile, electronic message, or a voice call, as indicated at 495.

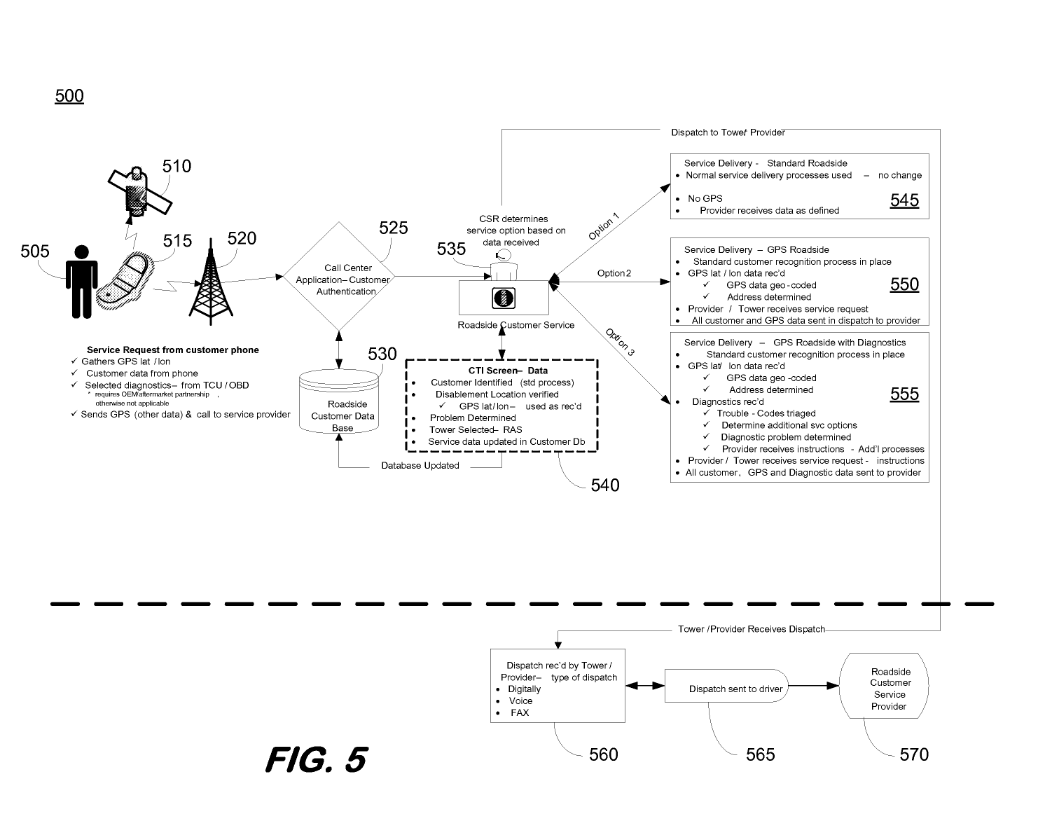

FIG. 5 is an exemplary illustration of a service delivery process and system 500, from a user perspective, in accordance with some embodiments disclosed herein. Accordingly, customer 505 initiates a voice call to a service provider 535 to request a particular service using mobile phone device 515. In response to the service request call, GPS data, customer data, diagnostic data (if available) is gathered and forwarded in a data transmission to a call center for service provider 535 over a carrier network 520, thereby invoking a call center application 525. Call center application 525, in cooperation and communication with customer database 530, operates to collect, store, and update customer information relative to the request for service.

Based on the voice call received from customer 505 and the data transmission associated with the request for service, a customer service representative or an automated process at service provider 535 determines a level of service to render in reply to the request for service from customer 505. Module 540 is an exemplary illustration of some of the information provided at service provider 535 to facilitate responding to the request for service.

Service provider 535 may determine that one of a plurality of levels of service should be rendered in reply to the request for service based on the information received and associated with the request for service. In FIG. 5, three levels of service 545, 550, and 555 may be rendered. It should be appreciated that fewer, more, different, and alternative levels of service may potentially be rendered in some embodiments herein.

Service level 545 is provided in the instance customer 505, and in particular mobile phone device 515, does not provide GPS data. Such a level of service responds to the request for service by rendering services not dependant on GPS data.

Service level 550 is provided in the instance customer 505, and in particular mobile phone device 515, does provide GPS data. Such a level of service includes responding to the request for service by rendering services that, in some embodiments, depend or otherwise use the GPS data associated with the request for service. Exemplary details of service level 550 are shown in FIG. 5.

Service level 555 is provided in the instance customer 505, and in particular phone device 515, provides GPS data and diagnostic information. Such a level of service includes responding to the request for service by rendering services that, in some embodiments, depend or otherwise use the GPS data associated with the request for service. Further, response 555 may be particularly configured to suit customer 505 based on the diagnostic information received by service provider 535. Exemplary details of service level 555 are shown in FIG. 5.

Process 500 continues with service provider entity 535 by dispatching a responder to respond to the customer request for service at 560. The dispatch may be sent to a responder at 565 that is to deliver the requested service at 570 after service provider 535 determines which level of service is to be delivered in response to the customer's request for service.

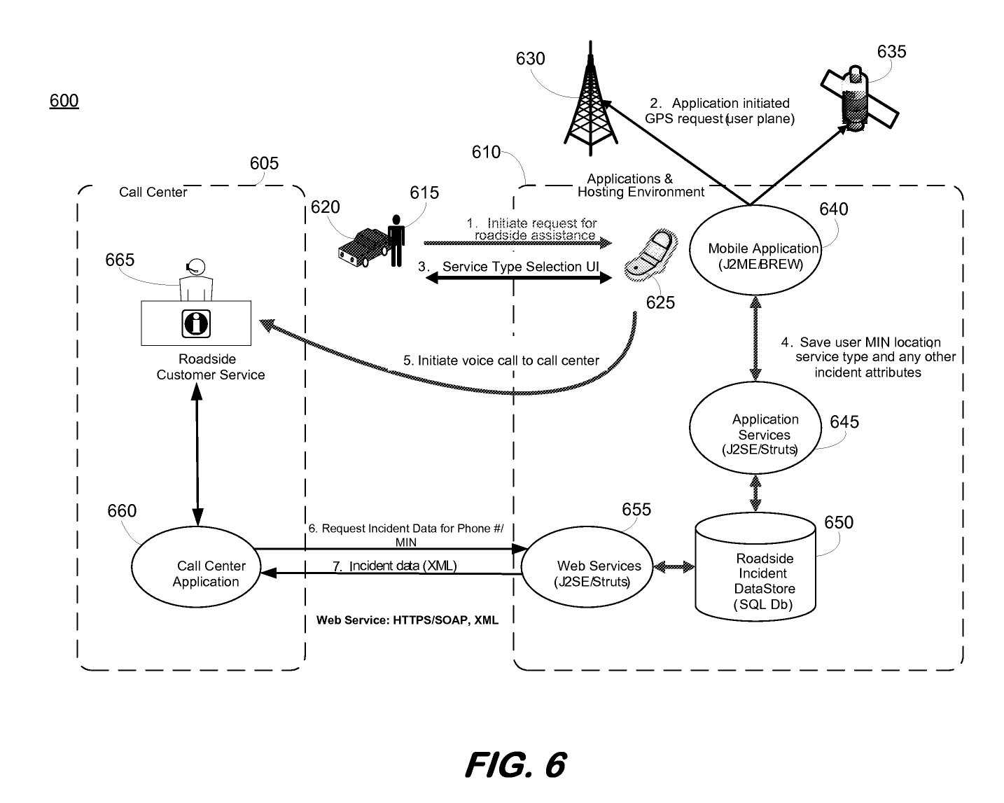

FIGS. 6-8 provide an overview of a service delivery process and system, in accordance with some embodiments herein. FIG. 6 relates to a service delivery process 600 that includes a call center 605 operating in cooperation with an application and hosting environment 610 to deliver a service to a customer 615. The delivery process begins with customer 615 requesting the service (i.e., roadside assistance) due to, for example, an emergency related to vehicle 620. The request may be made through a user interface of phone device 625. A location of phone device 625 may be obtained or determined by GPS satellite 635 and a mobile application 640 to facilitate the request. Application services 645 may be invoked to further process the request for service via phone device 625. A record of the request and information related thereto (e.g., GPS location, level of service desired, etc.) may be maintained at database 650.

Web services 655 may be used to convey information related to the request for service (i.e., incident data) to call center 605. Call center application 660 may request general or specific information regarding the request for service including, for example, information contained in the record of the request for service stored in database 650. Requested incident data may be delivered to call center application 660 in reply to the request for information from call center application 660. The delivered incident data may be further delivered to service provider customer service representative 665. Customer service representative 665 may also receive a voice call from customer 615. Customer service representative 665 may be able to further process the request for service given the reception of the voice call and the incident data transmission.

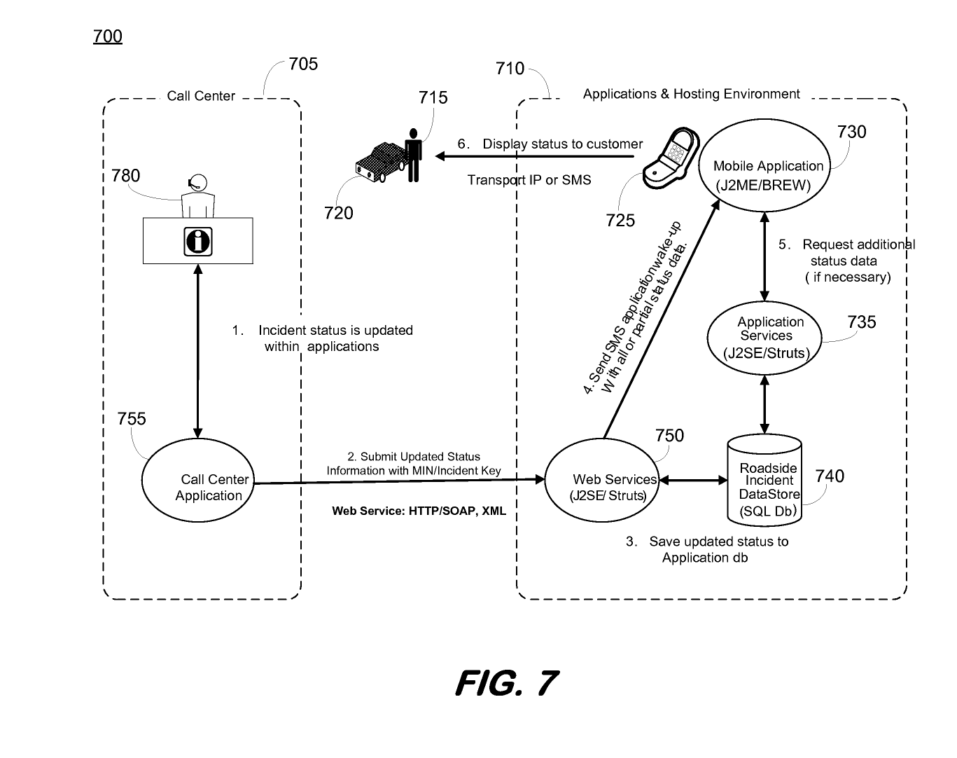

FIG. 7 further illustrates aspects of the service delivery process. In particular, FIG. 7 illustrates a customer service status update process 700. An incident status may be updated with applications by a customer service representative 780 at a call center 705 for a service provider 705A call center application 755 may be used to provide updated status information to an application and hosting environment 710. The application and hosting environment 710 may provide the updated status information by a call center application 755. The updated status information may include, for example, a MIN or other identification key.

Web services 750 operate to receive the updated status information, as shown in FIG. 7. The updated status information or a corresponding record thereof may be saved in database 740. Also, web services 750 may send a communication (e.g., text message, SMS message, etc.) to a mobile application loaded on phone device 725 to wake-up or invoke the mobile application with at least some of the updated status information to provide a status update to customer 715 via phone device 725. Mobile application 730 may access database 740 using an application service 735 (if necessary or selected). The updated status information which is updated based on input from customer service provider 780 and may include a comparison with a record in database 740 is provided, displayed, or otherwise presented to customer 715 located at or associated with vehicle 720 by transmitting the updated status information to mobile phone device 725.

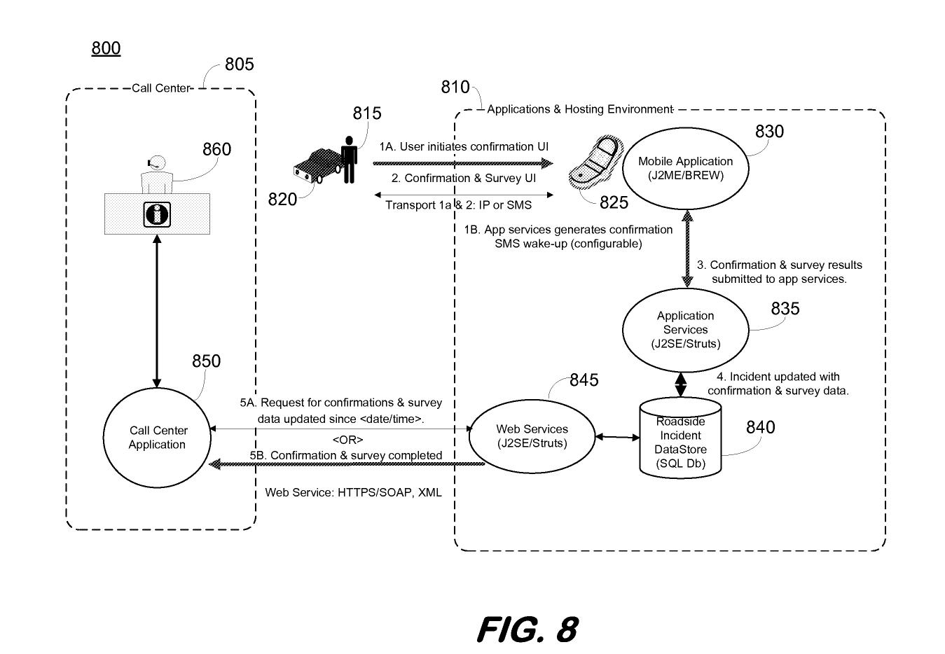

FIG. 8 illustrates aspects of the service delivery process. In particular, FIG. 8 illustrates a customer service confirmation and survey process 800. Process 800 may begin with customer 815 associated with a vehicle 820 initiating a confirmation process through a user interface of phone device 825. Customer 815 may be asked to confirm information related to the delivery of a service and to participate in a survey regarding the delivery of the service.

FIG. 8 also illustrates aspects of the service delivery process. In particular, FIG. 8 illustrates a confirmation and survey aspect, process 800, for the service delivery process. Process 800 may include a call center 805 operating in cooperation with an application and hosting environment 810 to provide the confirmation and survey aspects of the service delivery process to customer 815. Process 800 may begin with customer 815 initiating confirmation of a service (i.e., roadside assistance) delivery regarding, for example, vehicle 820, using a user interface present on phone device 825. Mobile application 830 may be invoked to initiate the confirmation and survey input by customer 815. Application services 835 may be invoked to further process and deliver a record of the confirmation and survey results to a database 840.

Web services 845 may be further used to convey information related to the confirmation and survey results, including incident data, to call center 805. Call center application 850 may request general or specific information or data regarding the confirmation and survey results updated since a specific time and/or upon completion of a survey. The confirmation and survey results may be delivered to a service provider 860 (or a proxy or agent of the service provider). The confirmation and survey results may be used to, for example, monitor, enhance, modify, and improve the efficiency of services delivered by service provider 860.

In certain embodiments, the present invention may be partially or wholly implemented with a computer-readable medium, for example, by storing computer-executable instructions or modules, or by utilizing computer-readable data structures. Of course, the methods and systems of the above-referenced embodiments may also include other additional elements, steps, computer-executable instructions, or computer-readable data structures.

Although the present invention has been described with respect to particular embodiments, including alternative arrangements thereof, those skilled in the art will note that various substitutions may be made to those embodiments and arrangements without departing from the spirit and scope of the present invention.

What is claimed is:

1. A method for enrolling with a service, the method comprising:
receiving a selection of a service from a mobile phone device;
authenticating a user of the mobile phone device with a carrier associated with the mobile phone device;
determining GPS functionality of the mobile phone device;
enrolling the user of the mobile communication device with the service based on the authentication and the determined GPS functionality of the mobile phone device; and
transmitting an application associated with the service to the mobile phone device of the enrolled user based on the GPS functionality of the mobile phone device.

2. The method of claim 1, further comprising maintaining a record of the enrolled user, the record including an indication of the GPS functionality of the mobile phone device.

3. The method of claim 1, wherein the mobile phone device comprises at least one of a mobile phone, a VOIP (voice over internet phone) device, a wireless phone, and a device including mobile telephony functionality.

4. The method of claim 1, wherein the enrolling step further comprises:
transmitting enrollment options;
transmitting terms and conditions associated with enrolling the user with the service;
receiving an indication of acceptance of the transmitted terms and conditions; and
receiving a selected enrollment option based on the transmitted enrollment options. .

5. The method of claim 1, wherein the determining step comprises verifying the GPS functionality of the mobile phone device with the carrier.

6. The method of claim 2, wherein the record of the enrolled user is provided to a service provider of the service.

7. The method of claim 6, wherein the service provider maintains a record of the user, the record including an enrollment status of the user and the indication of the GPS functionality of the mobile phone device associated with the user.

8. A method of providing a service to a customer, the method comprising:
receiving a request for service via a mobile phone device;
gathering GPS data associated with the mobile phone device;
sending the GPS data to a service provider;
placing a voice call to the service provider;
associating the sent GPS data with the placed voice call;
determining a level of service to provide to the customer; and
dispatching a responder based on the determined level of service to a location associated with the GPS data.

9. The method of claim 8, wherein the step of receiving a request for service comprises receiving a code associated with the service.

10. The method of claim 8, wherein the step of dispatching the responder comprises providing the responder with an indication of the determined level of service and the GPS data.

11. The method of claim 8, wherein the level of service is at least one of a call for service, a status check, a diagnostic operation, and a customer information update operation.

12. The method of claim 8, including determining a location of the customer based on the GPS data.

13. The method of claim 1, wherein the service comprises a roadside assistance service.

14. The method of claim 8, wherein the service comprises a roadside assistance service.

15. A computer-readable medium containing computer-executable instructions for causing a computer device to perform the steps comprising:
receiving a selection of a service from a mobile phone device;
authenticating a user of the mobile phone device with a carrier associated with the mobile phone device;
determining GPS functionality of the mobile phone device;
enrolling the user of the mobile communication device with the service based on the authentication and the determined GPS functionality of the mobile phone device; and
transmitting an application associated with the service to the mobile phone device of the enrolled user based on the GPS functionality of the mobile phone device.

16. The computer-readable medium of claim 15, wherein the enrolling step further comprises:
transmitting enrollment options;
transmitting terms and conditions associated with enrolling the user with the service;
receiving an indication of acceptance of the transmitted terms and conditions; and
receiving a selected enrollment option based on the transmitted enrollment options.

17. The computer-readable medium of claim 15, wherein the determining step comprises verifying the GPS functionality of the mobile phone device with the carrier.

18. The computer-readable medium of claim 15, further comprising maintaining a record of the enrolled user, the record including an indication of the GPS functionality of the mobile phone device.

19. The computer-readable medium of claim 18, wherein the service provider maintains a record of the user, the record including an enrollment status of the user and the indication of the GPS functionality of the mobile phone device associated with the user.

20. The computer-readable medium of claim 15, wherein the service comprises a roadside assistance service.
